(19) United States
(12) Patent Application Publication
(10) Pub. No.: US 2003/0138315 A1
(43) Pub. Date: Jul. 24, 2003

(54) Sky turbine-city

(76) Inventor: Manfred K. Brueckner, Milwaukee, WI (US)

Correspondence Address: Manfred K. Brueckner, 818 S. 105th Street, Milwaukee, WI, 53214-2544, US

(21) Appl. No.: 10/051,521

(22) Filed: Jan. 18, 2002

(51) Int. Cl. F03D 7/02

(52) U.S. Cl. 415/4.5

(57) ABSTRACT

A sky turbine mounted atop a high rise city. Capable of protecting itself from high sky speeds by telescoping its impeller blades into a smaller diameter. Providing all mankind with clean, abundant electric power, too cheap to meter.

### FIELD OF INVENTION

This invention relates to the production of cheap, clean, perpetually abundant electric power.

### BACKGROUND OF THE INVENTION

At the present time, electricity is produced by hydroelectric dams, atomically or the burning of hydrocarbons. Production of electricity by hydroelectric dams is limited and is also destructive to the environment. With my invention, dams may be dismantled and the salmon may return to their run. The burning of coal deposits mercury and acid rain into the environment. Toxic ash must also be disposed of. Atomic power production is plagued with the problem of long term storage of radioactive waste.

### SUMMARY OF THE INVENTION

In accordance with the present invention, a sky turbine is mounted atop a high rise city. Two main shafts are facing forward and two are facing aft. Both pair are intermeshing and counter rotating. There is no timing relationship between front and back. In fact, the front side may be shut down for maintenance while the back side continues producing power. This invention has the ability of the sky turbine to protect itself from unduly high sky speeds. As the sky speeds rises, the impeller blades have the ability to telescope themselves into a smaller radius.

### DESCRIPTION OF DRAWINGS

FIG. 1 is a isometric overview of a style A sky turbine. My invention would have this appearance when the sky speed is 2.7 M/S (6 mph) or less. Each blade may have between 5 to 12 panels. The presentation shown in FIG. 1 has nine panels, reference 1 through 9.

FIG. 2 is an enlarged view of one impeller blade which is mounted at the left rear spinner.

FIG. 3 is similar to FIG. 1 but shows the invention as it would appear when the sky speed is between 5.8 and 7.6 M/S (13 and 17 mph). Panels 2 through 4 have been telescoped into panel 1.

FIG. 4 compliments FIG. 3.

FIG. 5 shows the arrangement of the invention as it would appear when it is facing a sky speed of between 14.3 and 21.5 M/S (32 and 48 mph). Panels 2 through 7 have now been telescoped within panel 1.

FIG. 6 compliments FIG. 5.

FIG. 7 shows the invention when facing a sky speed greater than 21.5 M/S (48 mph). Also shown is arrow 10 which is indicating the direction of the sky as it approaches the invention. Tower 11 contains the stationary portion of the city. Wing 12 connects the city to the pods. The right front spinner 13 is mounted onto the right pod 14. Some of the cities most luxurious real estate is located just within the skin of the wing and pods. A weather station 15 located atop wing 12 contains an anemometer and a sky direction vane. A computer (not shown) located near the weather station 15 communicates with and commands (via digital radio signals) the various servo motors located throughout the blades. A pair of wires (not shown) are strung the length of each spar. Continuity from spar to spar is maintained by electric brushes. Thus, power is provided to all servo motors within the blade. Servo motors are also mounted on tower 11 to keep wing 12 facing arrow 10.

FIG. 8 compliments FIG. 7.

FIG. 9 is similar to FIG. 8, but shows that the computer has set the blades to a low angle of attack as the invention faces a hurricane. The invention continues to produce power.

FIG. 10 is a left side elevation view of a style A turbine. H dimension is the height as measured from the ground.

FIG. 11 is a top view of my invention. Dimension D is the dihedral angle of the blades with respect to the spinner and dimension S is the skew angle between the spinner and the center of symmetry. The sky speed at altitude is more than two times the speed at the ground. (Marks' Standard Handbook, 9^{th} Edition, p. 9-173, FIG. 9.11.18). The skew angle subtracts angle of attack at the top of the swing and adds angle of attack at the bottom of the swing. With the right front blades rotating clockwise (when viewed from the front), the skew angle will automatically compensate for the difference of the sky speed at the various altitudes.

FIG. 12 and FIG. 13 shows the telescoping of panel 1 over panel 2 in 90° of the blade swing. This is possible because the blades rotate quite slowly. That is a tip speed to sky speed of approximately six times.

$$Or RPM = \frac{{kS}_{s}}{R}$$

whereby

RPM: revolutions per minute of the blades

k: a constant 57 (84)

S_{S}: mean sky speed in M/S (mph)

R: the total radius of the blades in meters (feet)

The reciprocal of the RPM is the number of minutes required to complete one revolution.

The falling motion is powered by gravity and this fall is checked by severo motors located inside the blade.

FIG. 14 and FIG. 15 shows the inverse of FIG. 12 and FIG. 13. Panel 1 extends during 90° of blade rotation and this fall is again due to gravity.

FIG. 16 through FIG. 20 shows the various aspects of a style B embodiment. This style differs from style A in that the wing 12 is integral with the city 18. Both suspended by tower 17. In the version shown there is no skew angle, therefore, additional dihedral must be used. Reference 16 is a two channel rotating union allowing fresh water to enter the city and sewage to exit.

FIG. 21 is a section through a five paneled blade. This blade is shown with a zero angle of attack on all panels, (full feathered). Each panel is equipped with a seal 31. This seal keeps out moisture and strips off ice when the panels are in relative motion. Planetary gear 34 is a hypocycloid roller gear and increases the speed of the main shaft 32 25.5 times faster than the spinner 13. The main shaft 32 is held to the stationary structure 35 by bearing 33. A light structural lattice 36 is provided to give the panels airfoil a semi-monocoque strength.

FIG. 22 is a retracted configuration of FIG. 21. Typically the number of panels range between 5 and 12. The length ratio of retracted to extended is a function of the total number of panels. Therefore the more panels, that are fitted, the better the invention can protect itself from violent storms. Strobe light 30 warns approaching aircraft.

FIG. 23 is the airfoil of the panels skin. This airfoil is symmetrical. The center of pressure is stable for all angles of attack. This is well known. (Handbook of Airfoil Sections, Rice, Michael, 1971, p. 47). This airfoil cannot flutter (shimmy). Cord C is the total length. The maximum width B is located ⅓ of the cord as measured from the front. ⅓ cord also equals ½ A.

Thus

$$\frac{C}{3} = \frac{A}{2} or \frac{C}{1.5} = A$$

and the leading edge radius

$$r = \frac{{B}^{2}}{2 A}$$

Furthermore

$$X = \frac{{A}^{3} - 3 A {B}^{2} + 2 {B}^{3}}{4 B ( A - B )}$$

Finally

$$R = X + \frac{B}{2}$$

Both the cord C and dimension B may be arbitrarily chosen. Center 39 is the center of gravity of the airfoil and the axis of the telescoping octagonal mono spar.

FIG. 24 is a section taken through FIG. 22. Each panel is equipped with two ball screws 19 through 22. (This figure has distorted proportions for the sake of clarity).

FIG. 25 is a section taken through FIG. 24.

FIG. 26 is an isometric view of the inside of the right hand pod 14. Main shaft 32 is rotating 25.5 times faster than spinner 13. Shaft 40 synchronizes the right main front shaft to the left main front shaft. The main shaft 32 is supported by pillow block 41 at its back end. Two universal joints 42 remove the skew angle before providing the nine speed gear box 43 with input. The output of this gear transmission 43 is fed into a bank of fixed displacement oil pumps 44 and also into a small bank of variable displacement pumps 45. The combined oil pumped is fed to a fixed displacement hydraulic motor 46 through pipe 47 and returned to the pumps by pipe 48. The motor 46 is directly coupled to A.C. generator 49. A small sample of electric power is taken from generator 49 by wires 50 and fed to a synchronous motor 51. The speed of motor 51 is compared by differential 52 to a clock 53. If generator 49 is operating off frequency, variable displacement pumps 45 are readjusted through feedback tube 54. A.C. power from generator 49 is supplied to all local loads by wire 55. Location 56 contains equipment to convert A.C. to D.C. This D.C. is sent worldwide by power grid 57. On rare occasions when the sky speed falls below 4 mph, the sky turbine may no longer have sufficient strength to supply its designated area with A.C. power. In that situation, D.C. power is borrowed from grid 57 and converted back to A.C. by 56 to be used locally through wires 55.

FIG. 27 shows the relative efficiency of investment capital with respect to dimension H. Eiffel's tower (Paris) 58 is shown for height comparison. When the H dimension is doubled, the electric power is increased four times and the city's real estate is eight times more. Investment capital is largely recovered by the selling and renting of the city's real estate. The electric power, however, would be so plentiful that it would be too cheap to meter.

FIG. 28 shows the number of panels which are extended outward (out of a total of nine panels) with respect to the sky speed.

FIG. 29 is a map of the Gulf of Mexico, depicting hypothetical locations of my invention 59. Also shown is the worldwide D.C. power grid 57. When this grid is submerged 57a. The local area 60 is supplied with A.C. power from wires 55.

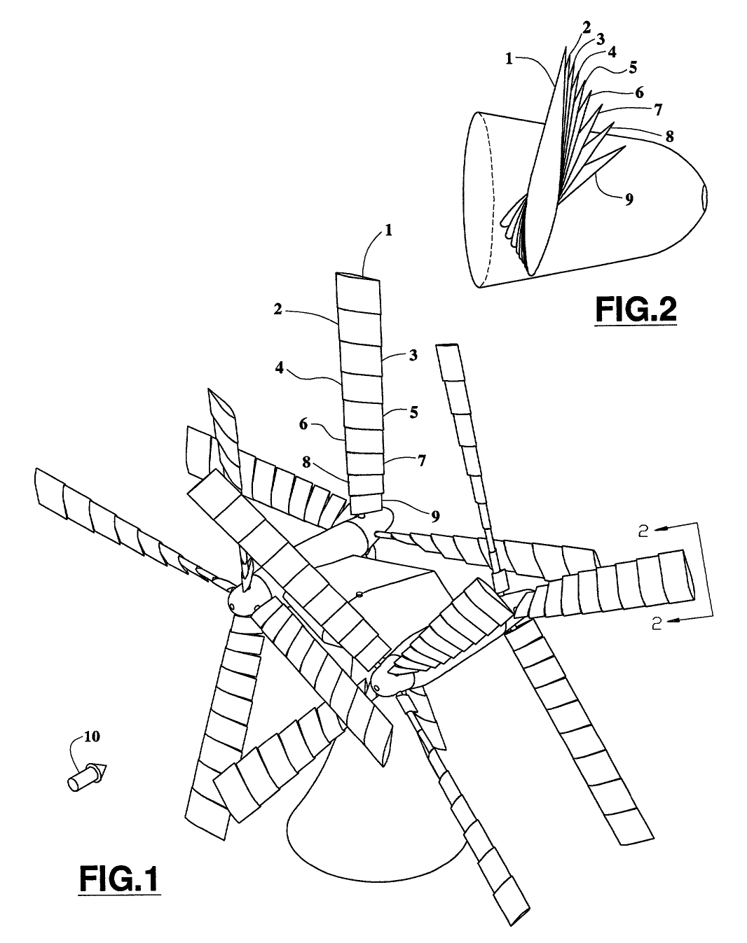

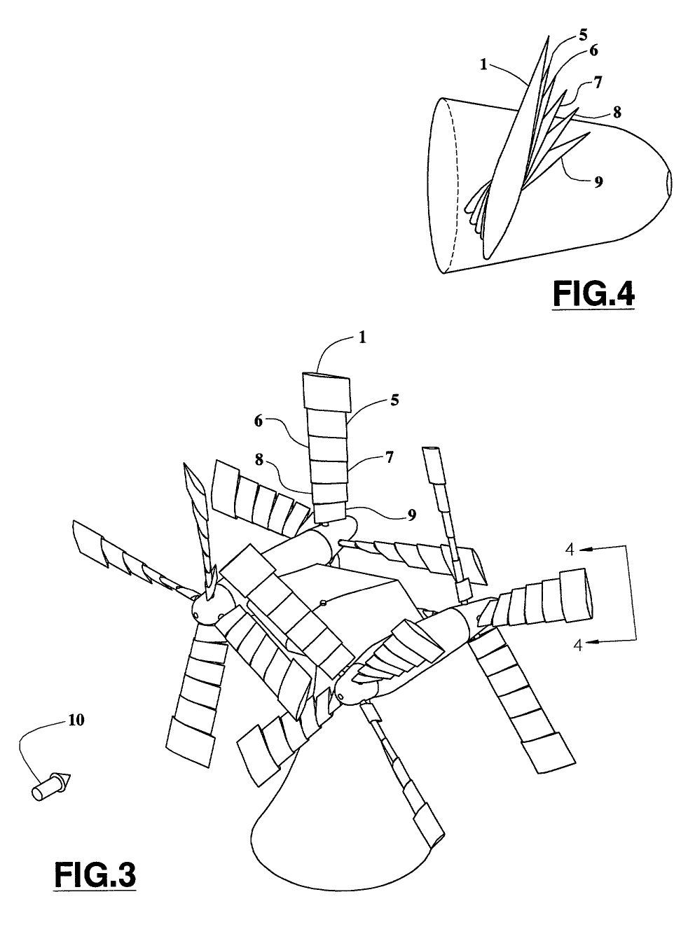

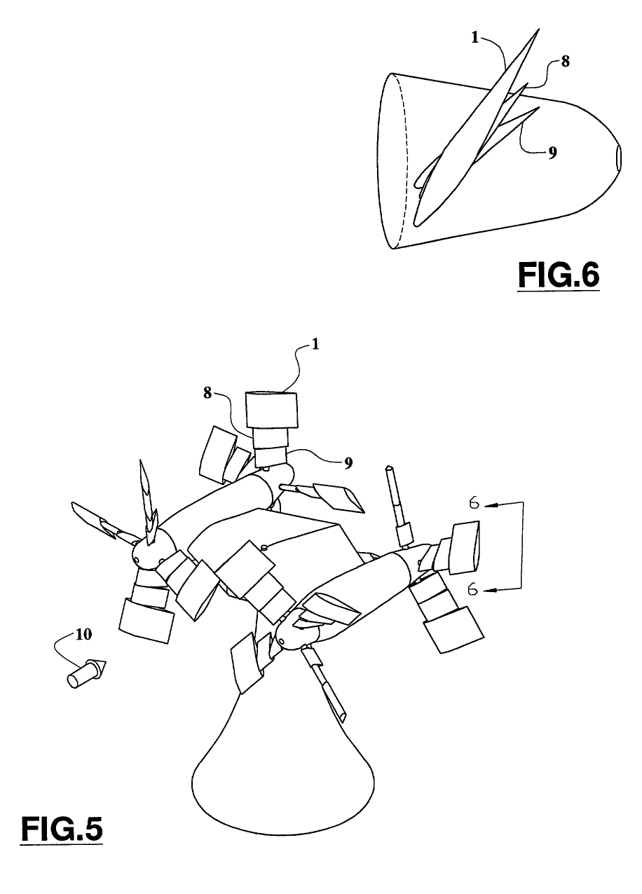

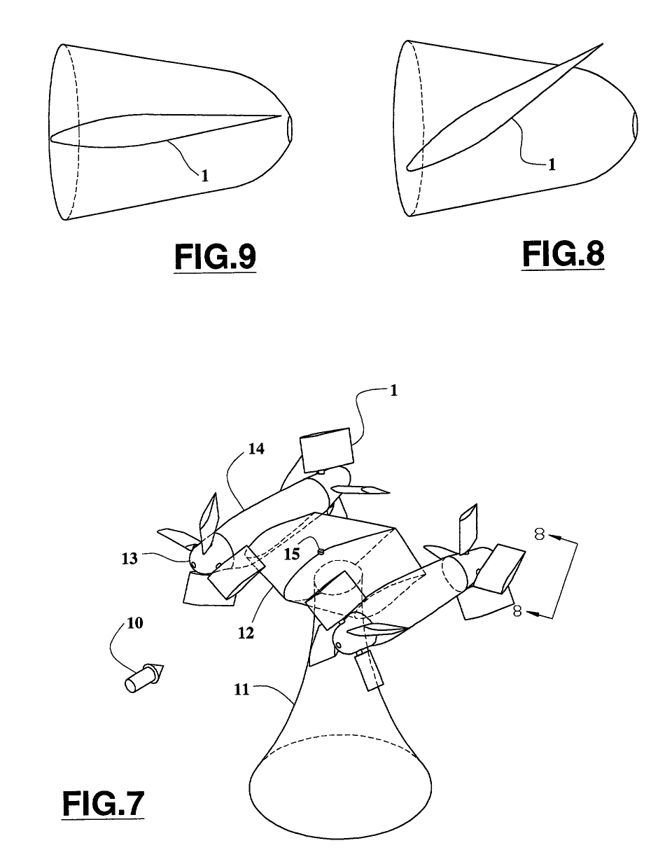

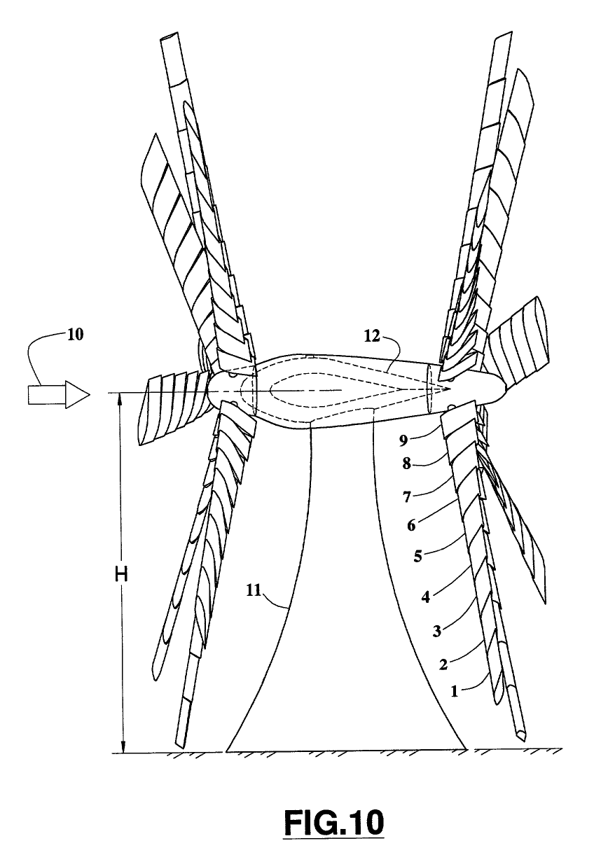

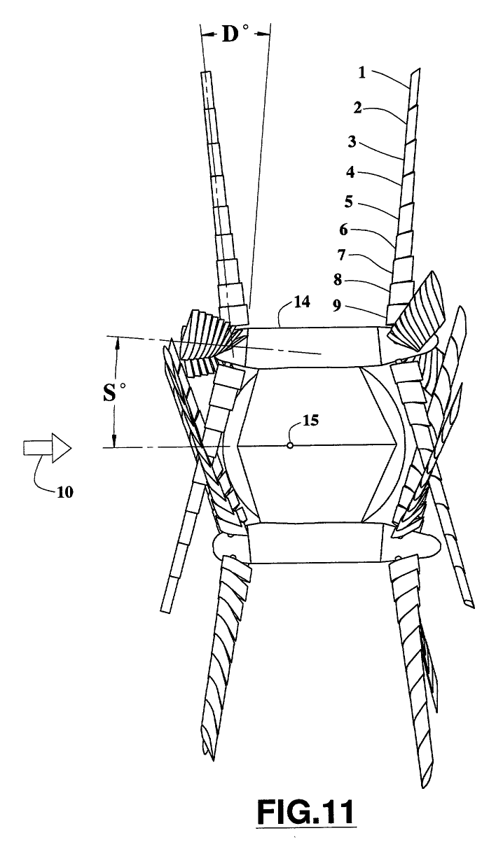

### DESCRIPTION OF PREFERRED EMBODIMENT

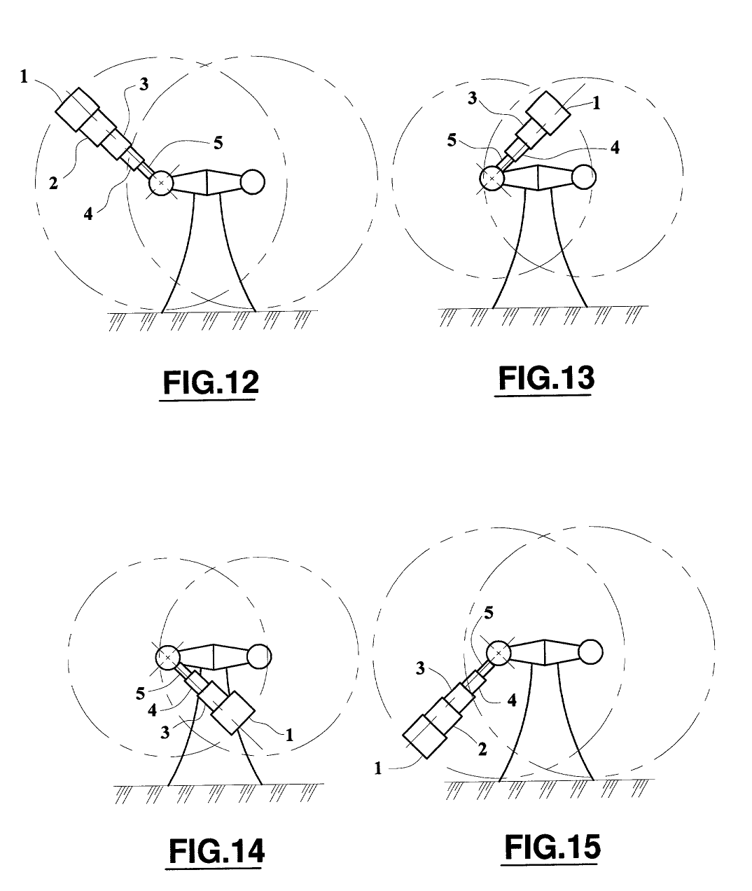

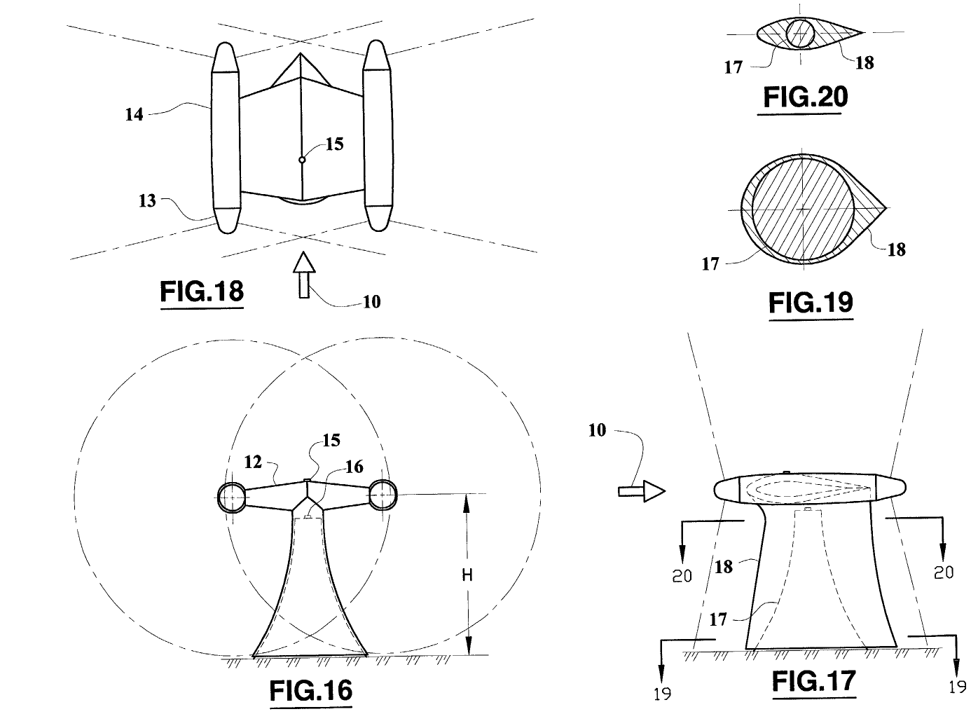

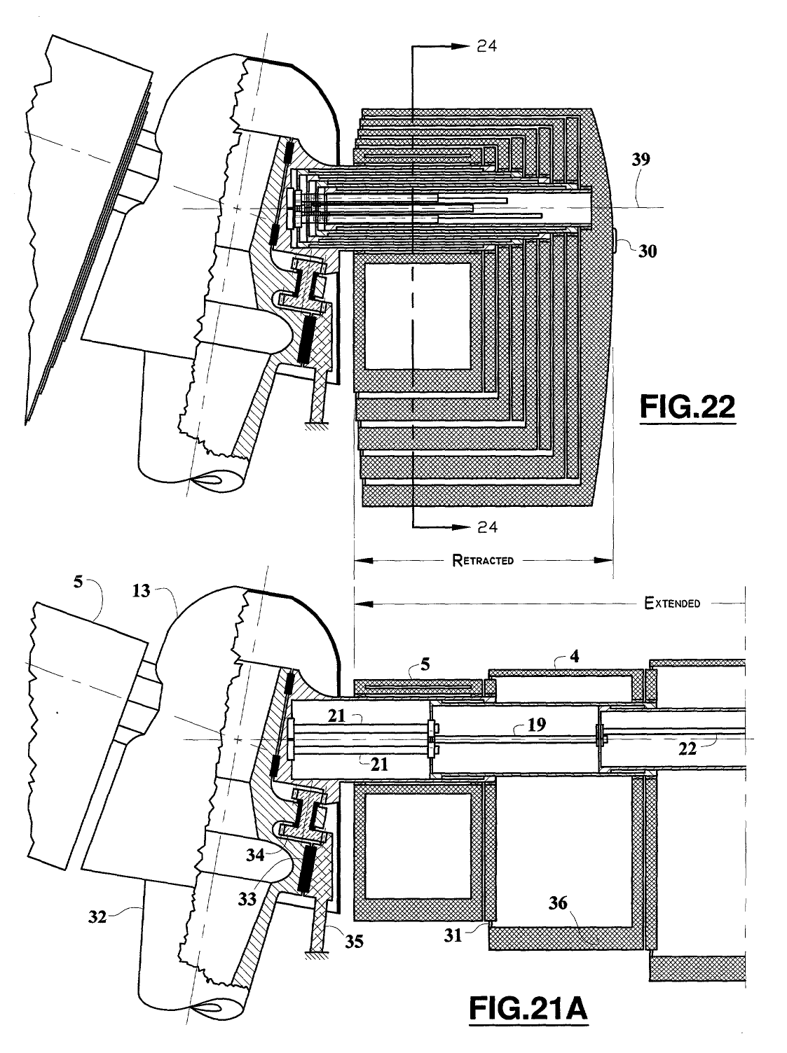

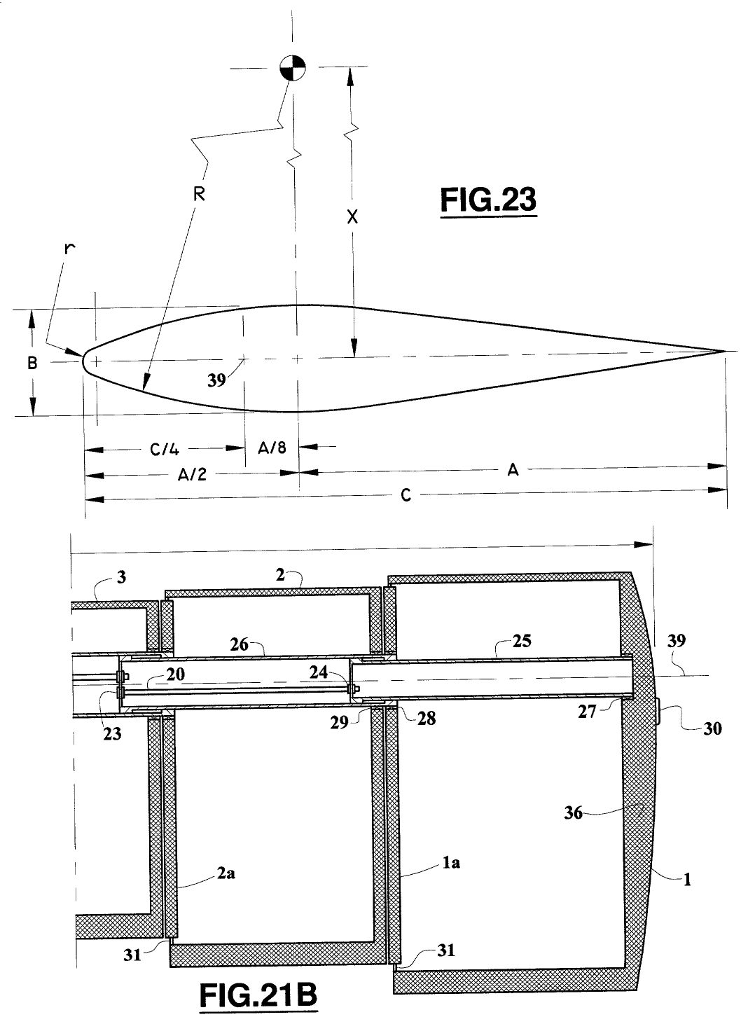

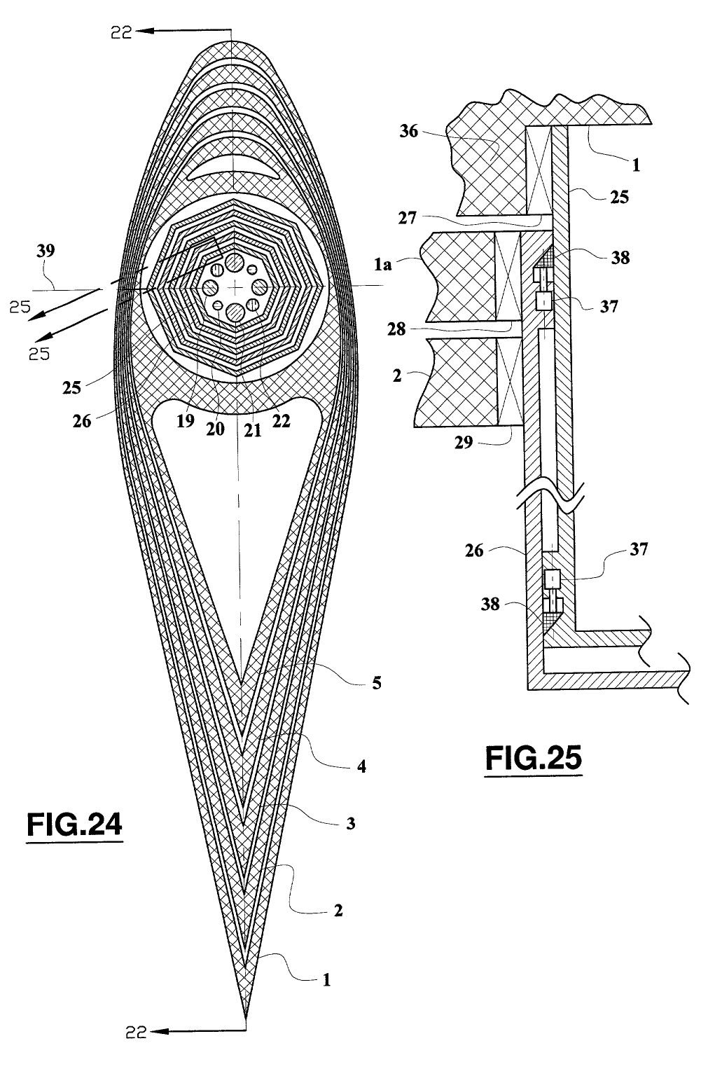

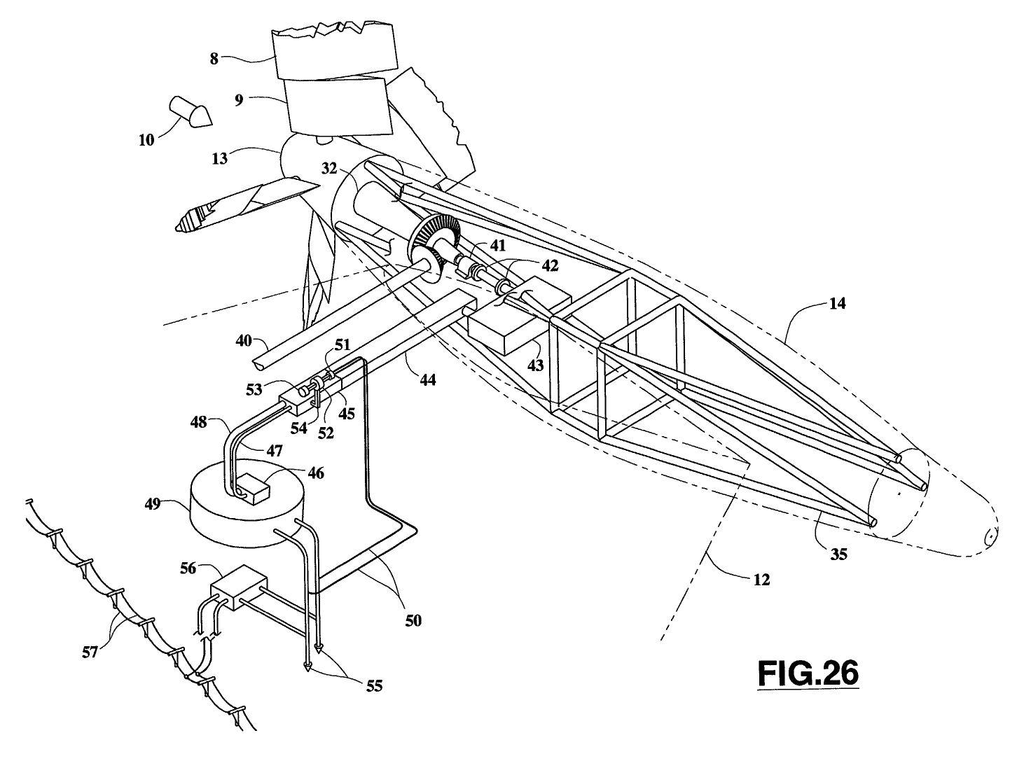

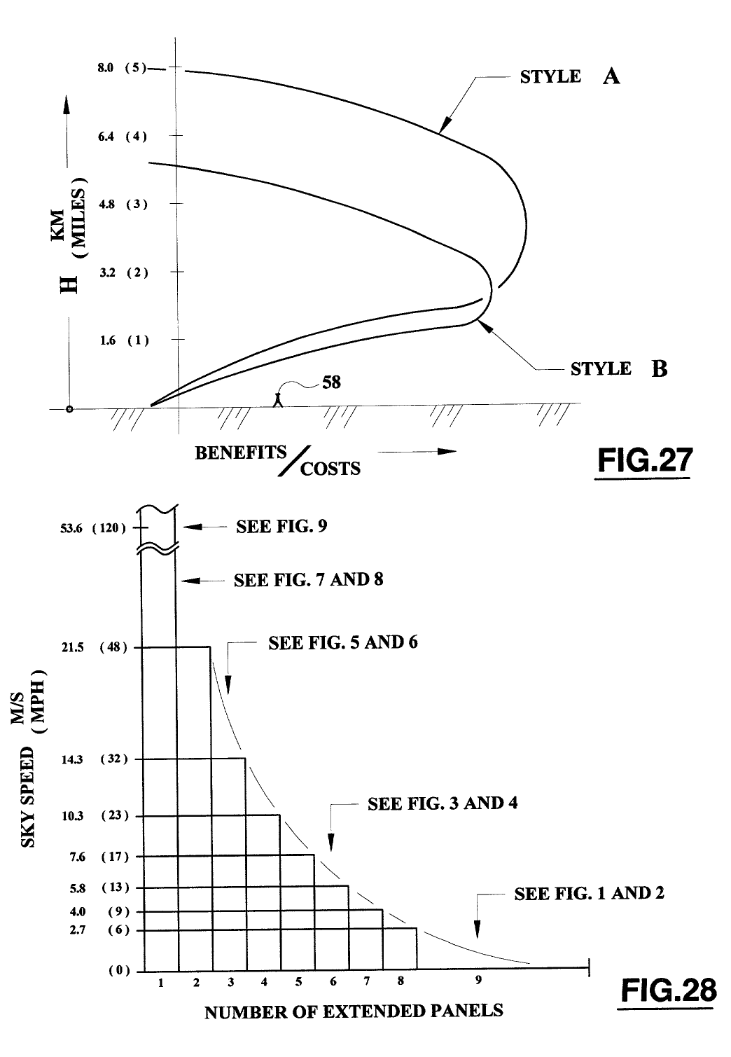

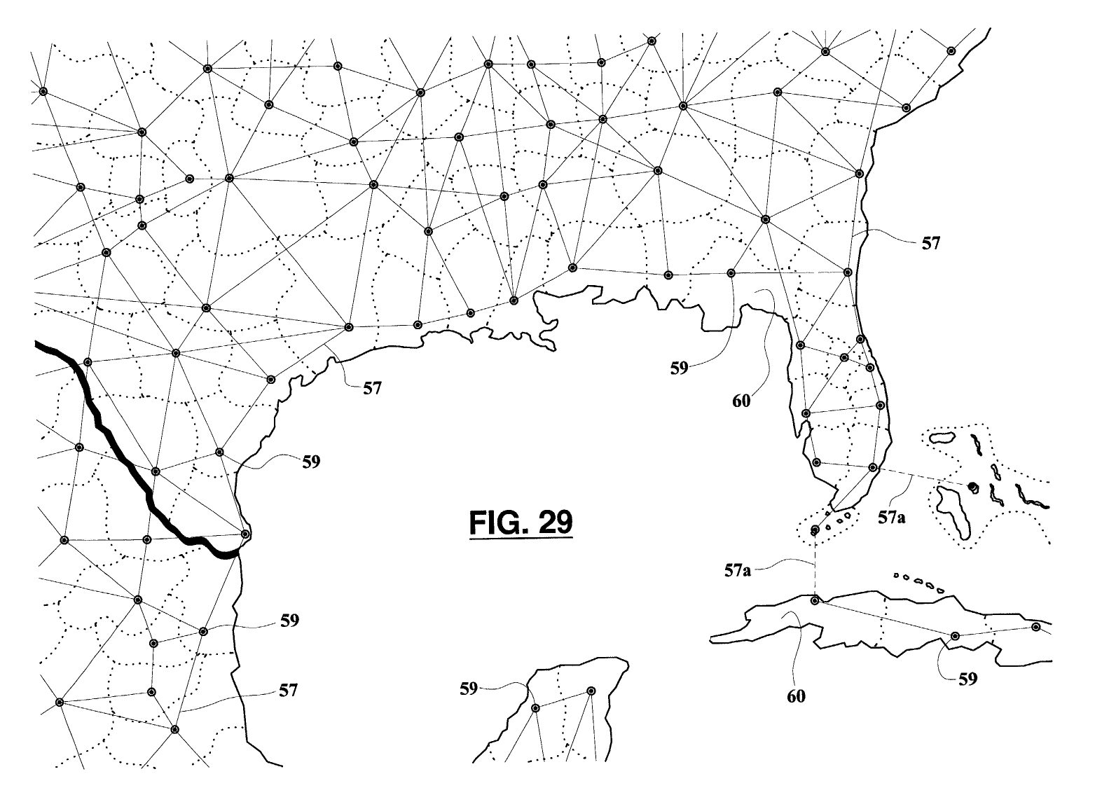

In operation, weather station 15 reports to the computer that the sky speed has increased over 2.7 M/S (6 mph). (See FIG. 28). The computer decides that it is time to retract panel 1 over panel 2. The computer then instructs panel 1 to align itself to panel 2, using simultaneously servo motors 27 and 28. (See FIG. 21B). It then instructs servo motor 37 to relax wedge 38. (See FIG. 25). Spar 25 is now free to slide down spar 26. (See FIG. 21B and FIG. 25). As panel 1 falls over panel 2, servo motor 23 decelerates this fall by using ball screw 20 and ball nut 24. Panel 1 then reaches its retracted position gently. Servo motor 37 then reactivates wedge 38 and a snug fit between spars 25 and 26 is re-established. All of this action takes place within 45° of blade rotation as shown in FIG. 12 and FIG. 13 and it is predominantly gravity driven.

1. A sky turbine mounted atop a high rise city.
Said sky turbine, located independently of windy locations.

2. The turbine of claim one wherein the impeller blades longitudinally adjust themselves to the prevailing sky speeds.

3. A symmetrical airfoil comprising:
a. a cord (C) its length,
b. its width (B),
c. a dimension (A) which is two-thirds its length (C),
d. a leading edge radius (r) which varies directly as the square of (B) and inversely as two times (A),
e. a line (M) perpendicular to the cord (C) and located at a distance (A) from the trailing edge,
f a dimension (X) varying directly as the cube of (A) minus three times (A) times the square of (B) plus two times the cube of (B) and inversely as four times (B) and inversely by (A) minus (B),
g. a radius (R) equal to the dimension (X) plus one-half of (B) centered on line (M), and
h. a straight portion, tangent to (R) and the trailing edge. (Airfoil shown in FIG. 23).
